(19) United States
(12) Patent Application Publication
(10) Pub. No.: US 2026/0211294 A1
(43) Pub. Date: Jul. 23, 2026

(54) VARIABLE APERTURE DESIGN FOR DEVICE Z-HEIGHT REDUCTION

(71) Applicant: Google LLC, Mountain View, CA (US)

(72) Inventors: Dansik Yoo, Sunnyvale, CA (US); Hyuk Jae Choi, Pleasanton, CA (US); Zhenhong Fu, San Jose, CA (US)

(21) Appl. No.: 19/028,609

(22) Filed: Jan. 17, 2025

(51) Int. Cl. G03B 9/06; G03B 30/00

(52) U.S. Cl. CPC G03B 9/06; G03B 30/00

(57) ABSTRACT

A example variable aperture for a camera of a mobile computing device includes a plurality of aperture blades, where a position of the plurality of aperture blades controls an amount of light that reaches a sensor of the camera. The variable aperture also includes a rotator configured to rotate the plurality of aperture blades along a rotational arc, where rotation of the plurality of aperture blades along the rotational arc adjusts the position of the plurality of aperture blades. The variable aperture also includes a base configured to house the rotator, the base defining a plurality of circumferentially distributed recesses, and where the rotator comprises a plurality of projections configured to move within the plurality of recesses.

### BACKGROUND

Existing optical systems of cameras in electronic products include variable apertures for controlling an amount of light imaged to a sensor. In mobile devices, the variable aperture may contribute to the amount of a bump height that a camera extends from the body of the mobile device.

### SUMMARY

In general, aspects of this disclosure are directed to techniques, systems, and lenses having a variable aperture. Example systems include a lens and a variable aperture including a plurality of aperture blades, a rotator configured to rotate the plurality of aperture blades to open and close the lens aperture, and a based configured to house the rotator and allow the rotator to rotate. The base may include a plurality of circumferentially distributed recesses, and the rotator may include a plurality of projections configured to move within the plurality of recesses. The base may also include a plurality of slots, each slot configured to enable insertion of a projection of the plurality of projections into a corresponding recess of the plurality of recesses, e.g., to allow the projections to be inserted into the recesses.

The techniques, systems, and lenses of this disclosure may provide one or more technical advantages and solve one or more technical problems. For example, the base may provide a barrier, e.g., the walls of the recess, configured to protect the rotator from contact with a variable aperture cover. For example, if the variable aperture cover deforms under a force (e.g., a contact force such as from dropping a device including the variable aperture), the base may protect the rotator from being contacted and deformed or bent. The base may enable reduction of the overall bump height of the system by enabling removal of a height relief designed to prevent deformation of bending of the rotator. For example, rather than including a designed height relief to protect the rotator from being contacted by the cover, the base may provide protection for the rotator without the height relief.

As one example, a variable aperture for a camera of a mobile computing device includes: a plurality of aperture blades, a position of the plurality of aperture blades controlling an amount of light that reaches a sensor of the camera; a rotator configured to rotate the plurality of aperture blades along a rotational arc, wherein rotation of the plurality of aperture blades along the rotational arc adjusts the position of the plurality of aperture blades; and a base configured to house the rotator, the base defining a plurality of circumferentially distributed recesses, wherein the rotator comprises a plurality of projections configured to move within the plurality of recesses.

As another example, camera of a mobile computing device includes: a lens configured to image light to a sensor; a variable aperture comprising: a plurality of aperture blades, a position of the plurality of aperture blades controlling an amount of light that reaches the sensor; a rotator configured to rotate the plurality of aperture blades along a rotational arc, wherein rotation of the plurality of aperture blades along the rotational arc adjusts the position of the plurality of aperture blades; and a base configured to house the rotator, the base defining a plurality of circumferentially distributed recesses, wherein the rotator comprises a plurality of projections configured to move within the plurality of recesses; and the sensor.

As another example, a method of assembling a variable aperture of a camera of a mobile device includes: inserting a rotator into a base, wherein the rotator comprises a plurality of projections and is configured to rotate a plurality of aperture blades along a rotational arc, wherein the base is configured to house the rotator and defines a plurality of circumferentially distributed recesses, wherein the base comprises the plurality of slots configured to enable insertion of a projection of the plurality of projections into a corresponding recess of the plurality of recesses, wherein inserting the rotator into the base comprises inserting the plurality of projections into corresponding slots of the plurality of slots; and inserting the plurality of projections, from the plurality of slots, into the plurality of corresponding recesses of the base.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a cross-sectional side view of an example camera including a variable aperture, in accordance with one or more aspects of the present disclosure.

FIG. 2 is an exploded view of an example variable aperture, in accordance with one or more aspects of the present disclosure.

FIG. 3A is a cross-sectional top view of a rotator within a base of an example variable aperture, in accordance with one or more aspects of the present disclosure.

FIG. 3B is a cross-sectional side view of the example variable aperture of FIG. 3A, in accordance with one or more aspects of the present disclosure.

FIG. 4 is an example computer system that may be used with the example camera of FIG. 1, in accordance with one or more aspects of the present disclosure.

FIG. 5 is a flow chart of an example method of assembling a variable aperture of a camera of a mobile device, in accordance with one or more aspects of the present disclosure.

### DETAILED DESCRIPTION

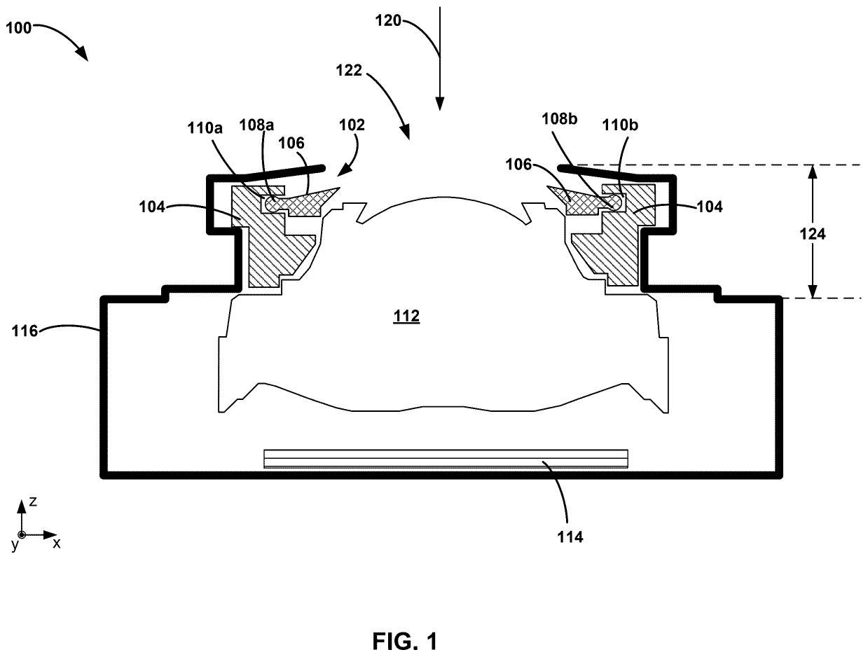

FIG. 1 is a cross-sectional side view of an example camera 100 including variable aperture 102, in accordance with one or more aspects of the present disclosure. In the example shown, camera 100 includes camera housing 116, lens 112, sensor 114, and variable aperture 102. Lens 112 is configured to image light 120 to sensor 114. Sensor 114 may be an image sensor, and may comprise an array of light sensitive pixels and/or detectors, e.g., focal plane array. Variable aperture 102 is configured to open and close to control an amount of light 120 imaged to sensor 114 by lens 112. For example, variable aperture 102 is configured to open to increase the area of a clear aperture 122 of camera 100 (to the point at which lens 112 becomes the aperture stop of camera 100) to allow an increased amount of light imaged by lens 112 to sensor 114, and variable aperture 102 is configured to close to decrease the area of the clear aperture 122 (to a point at which the aperture is fully closed) to decrease the amount of light imaged by lens 112 to sensor 114. Unless otherwise stated herein, variable aperture 102 “closing” the clear aperture 122 of camera 100 refers to reducing the area of the clear aperture 122, and variable aperture 102 fully closing, or being closed, refers to fully closing the clear aperture 122 of camera 100 to fully block light 120 form being imaged to sensor 114.

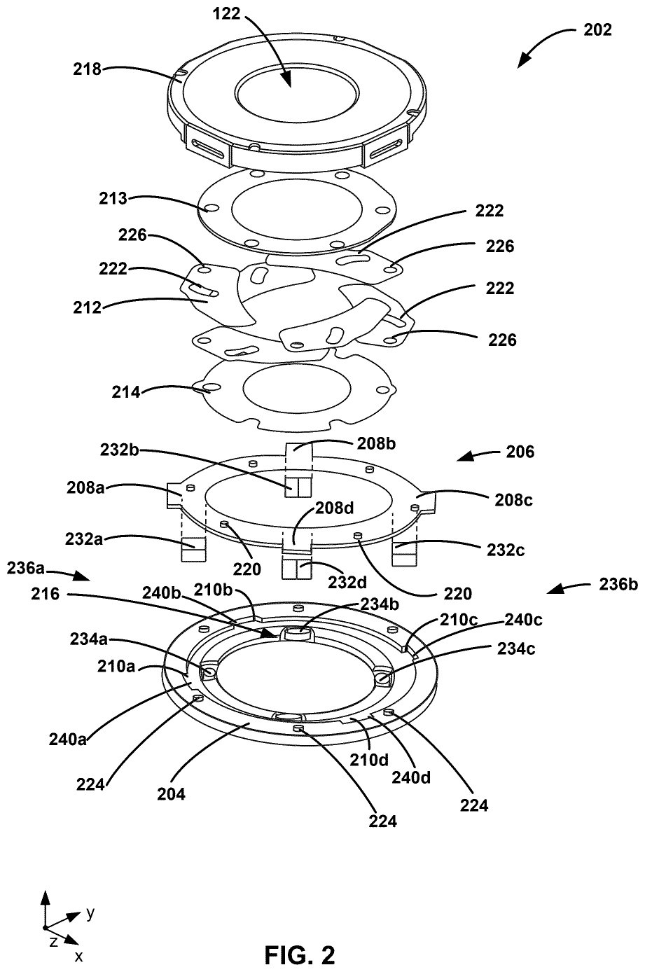

In the example shown, variable aperture 102 includes base 104 and rotator 106. Variable aperture 102 may also include one or more aperture blades (not shown), such as aperture blades 212 (FIG. 2), configured to be moved by rotator 106 to open and close the clear aperture 122 of camera 100. Base 104 may be configured to house rotator 106. For example, base 104 may be configured to support rotator 106 and enclose at least a portion of rotator 106 while allowing rotator 106 to rotatably move. For example, base 104 may define a recess and/or groove configured to receive at least a portion of rotator 106. In the example shown, base 104 defines recesses 110a and 110b (collectively, “recesses 110”). Although shown as two recesses 110a and 110b, base 104 may define fewer or more recesses 110, e.g., one recess, or three or more recesses. For example, base 104 may define a single recess that extends the full circumferential extent of base 104. In other examples, recesses 110 may extend for only a portion of the circumferential extent of base 104 and may be separate from each other. For example, base 104 may define a plurality of circumferentially distributed recesses 110, each recess 110 configured to receive at least a portion of rotator 106 and allow rotator 106 to rotate circumferentially for at least the circumferential distances or recesses 110. Base 104 may comprise a metal such as copper, steel, brass, a plastic, a ceramic, or any suitable material, e.g., a material having a stiffness and strength suitable to support and/or house components of variable aperture 102 such as rotator 106 and aperture blades.

Rotator 106 may be configured to rotate a plurality of aperture blades along a rotational arc to adjust a position of the plurality of aperture blades, as further described below. Rotator 106 may comprise a metal such as steel, aluminum, brass, a plastic and/or polymer, polytetrafluoroethylene (PTFE), a ceramic, or any suitable material configured to rotate aperture blades. In the example shown, rotator 106 includes a plurality of projections 108a, 108b (collectively, “projections 108”). Projections 108a and 108b may be configured to be positioned within recesses 110a and 110b, respectively, of base 104, and projections 108a and 108b may be configured to move within recesses 110a and 110b. That is, recesses 110a and 110b may be configured to receive projections 108a and 108b of rotator 106. Although shown as including two projections 108a and 108b, rotator 106 may include fewer or more projections 108, e.g., one projection 108, or three or more projections 108.

Projections 108 may be configured to move within recesses 110. In the example shown, projections 108 are configured to move within recesses 110 to rotate rotator 106 in the x-y plane. In some examples, projections 108 may be configured to roll within recesses 110, such as ball bearings. In other examples, projections 108 may be configured to slidably move within recesses 110, e.g., such as a plain bearing. In some examples, recesses 110 may be configured to allow projections 108 to slide within recesses 110, e.g., recesses 110 may include a lubricant, grease, oil, powder, or any suitable material to reduce and/or control friction between projections 108 and recesses 110. In the example shown, base 104 defines recesses 110 configured to surround, or enclose, projections 108 on three sides or from three directions, e.g., the top and bottom in the positive and negative z-directions, and the radially outwards side, to contain and/or protect rotator 106 from a force or from contacting a cover of camera 100 such as may occur from dropping a device including camera 100. In some examples, base 104 defines recesses 110 configured to surround, or enclose, projections 108 on two sides, e.g., the top and bottom in the positive and negative z-directions. In some examples, recesses 110 include, or are defined by, material configured to surround projections 108 for at least a portion of the rotational arc.

Rotator 106 may include posts configured to engage with aperture blades to cause the aperture blades to rotate the aperture blades along a rotational arc, e.g., a portion of the full circumference of base 104, to open and close the aperture of camera 100. For example, each post of rotator 106 may be configured to be received in a recess or through hole of a corresponding aperture blade of the plurality of aperture blades, and when an actuator causes rotator 106 to rotate, the posts of rotator 106 cause the aperture blades to rotate along a rotational arc. The rotation along the arc may also cause the plurality of aperture blades to move radially within clear aperture 122, e.g., to change the circumferential and radial positions of the aperture blades to open or close clear aperture 122. For example, actuators may be configured to cause rotator 106 to rotate in a first direction, and posts of rotator 106 may then cause the plurality of aperture blades to rotate along a rotational arc in a first circumferential direction and to move radially inwards such that the plurality of aperture blades pivot to fold radially inwards to reduce the area of clear aperture 122 (e.g., to “close” clear aperture 122). The actuators may be configured to cause rotator 106 to rotate in a second direction (e.g., the opposite direction), and posts of rotator 106 may then cause the plurality of aperture blades to rotate along a rotational arc in a second circumferential direction opposite the first circumferential direction and to move radially outwards such that the plurality of aperture blades pivot to spread radially outwards to increase the area of clear aperture 122 (e.g., to “open” clear aperture 122). The position of the plurality of aperture blades, e.g., circumferentially and radially, may control the amount of light 120 that reaches sensor 114 of camera 100, and the rotation of the plurality of aperture blades along the rotational arc adjusts the position of the plurality of aperture blades, e.g., to control the amount of light 120 that reaches sensor 114. In some examples, the plurality of aperture blades may be at least partially overlapping with respect to each other. In some examples, the plurality of blades form an iris of camera 100.

In some examples, base 104 may be configured to protect at least a portion of rotator 106. For example, walls of base 104 defining recesses 110 may provide a barrier from a material contacting at least a portion of rotator 106. For example, a force in the z-direction, e.g., substantially the same direction as light 120, on a cover (not shown) of variable aperture 102 may cause the cover to flex towards rotator 106, which may cause rotator 106 to flex and/or bend if allowed to contact rotator 106. Rotator 106 may be substantially thin and light, and may be deformed if allowed to bend and/or flex, e.g., in the z-direction. At least a portion of base 104 may be a physical barrier to the cover, or other component or material, from contacting at least a portion of rotator 106. For example, walls of base 104 defining recesses 110 may be robust to a contact force, e.g., the walls may not bend or flex under a contact force from the cover. Additionally, base 104 may provide a surface relief for portions of rotator 106 not positioned within recesses 110. For example, rotator 106 may be substantially planar, and the walls of base 104 defining recesses 110 may have a thickness that provides a z-height distance between the cover and rotator 106, thereby protecting rotator 106 may providing space to allow the cover to bend or flex without contacting rotator 106.

In some examples, variable aperture 102 may be configured to reduce bump height 124 of camera 100. For example, relative to a conventional variable aperture in which the rotator rotates along a surface of a base, variable aperture 102 may enable camera 100 to have a reduced surface relief height, e.g., a reduced z-height distance, between the cover and the rotator, the surface relief height being designed to allow the cover to bend and/or flex without contacting the rotator. By contrast, in the example shown, rotator 106 is moved from the surface of base 104, relative to a conventional variable aperture to be within the thickness (in the height- or z-direction) of base 104 such that base 104 provides a physical barrier to contacting at least a portion of rotator 106 and/or such that the thickness of base 104 provides the surface relief for rotator 106 such that the additional surface relief that may be needed with a conventional variable aperture may be reduced or removed. In some examples, bump height 124 may be 5 percent, or 10 percent, or 15 percent or more less than a bump height of a camera having a conventional variable aperture. In some examples, bump height 124 may be less than a bump height of a camera having a conventional variable aperture by equal to or more than an autofocus stroke length of camera 100. For example, bump height 124 may be reduced, relative to a camera having a conventional variable aperture, by equal to or more than 0.25 millimeters (mm), or 0.50 mm, or 0.62 mm, or 0.65 mm, or 0.70 mm, or 1.00 mm, or more.

FIG. 2 is an exploded view of an example variable aperture 202, in accordance with one or more aspects of the present disclosure. Variable aperture 202 may be an example of variable aperture 102 of FIG. 1. In the example shown, variable aperture 202 includes cover 218, spacers 213 and 214, aperture blades 212, rotator 206, flex circuit 216, and base 204.

Cover 218 may be configured to cover over, retain, and protect variable aperture 202 and components of camera 100, e.g., lens 112. Cover 218 may be made of a relatively stiff material, but may still be configured to flex in order to absorb a shock or force without cracking or breaking. Spacers 213 and 214 may be configured to provide separation between aperture blades 212 and both cover 218 and rotator 206 and/or to reduce friction between cover 218 (which may be configured to be stationary) and aperture blades 212, and reduce friction between rotator 206 and aperture blades 212 (portions of which may move radially in a direction rotator 206 does not move).

In the example shown, rotator 206 includes posts 220 configured to engage with aperture blades 212 to cause aperture blades 212 to rotate the aperture blades 212 along a rotational arc. In the example shown, posts 220 may be received within respective blade slots 222 defined by aperture blades 212. Base 204 may include another plurality of posts 224 configured to engage with aperture blades 212 to cause aperture blades 212 to pivot to move radially inwards or outwards as rotator 206 causes aperture blades 212 to rotate along the rotational arc. For example, posts 224 may be received within apertures 226 (e.g., holes 226) defined by aperture blades 212, and apertures 226 may function as pivot points for aperture blades 212.

Aperture blades 212 may be configured to control an amount of light that reaches a sensor, e.g., sensor 114. For example, aperture blades 212 may be substantially opaque. Aperture blades 212 may comprise a metal, a plastic and/or polymer, polyethylene terephthalate (PET), polytetrafluoroethylene (PTFE), a ceramic, or any suitable material configured to block light from reaching sensor 114, e.g., by reflecting and/or absorbing at least a portion of the light. In some examples, aperture blades 212 may be anodized and/or include a substantially black coating. Rotator 206 may be configured to rotate aperture blades 212 along a rotational arc to adjust the position of the plurality of aperture blades such that the aperture blades 212 fold radially inwards to control the amount of light that reaches sensor 114 by reducing the area of clear aperture 122, or such that the aperture blades 212 spread radially outwards to control the amount of light that reaches sensor 114 by increasing the area of clear aperture 122. The different positions of the plurality of aperture blades 212 along the rotational arc may correspond to different amounts of clear aperture 122 area, from fully closed where aperture blades 212 block light from reaching sensor 114 to fully open where aperture blades 212 allow a maximum amount of light to reach sensor 114.

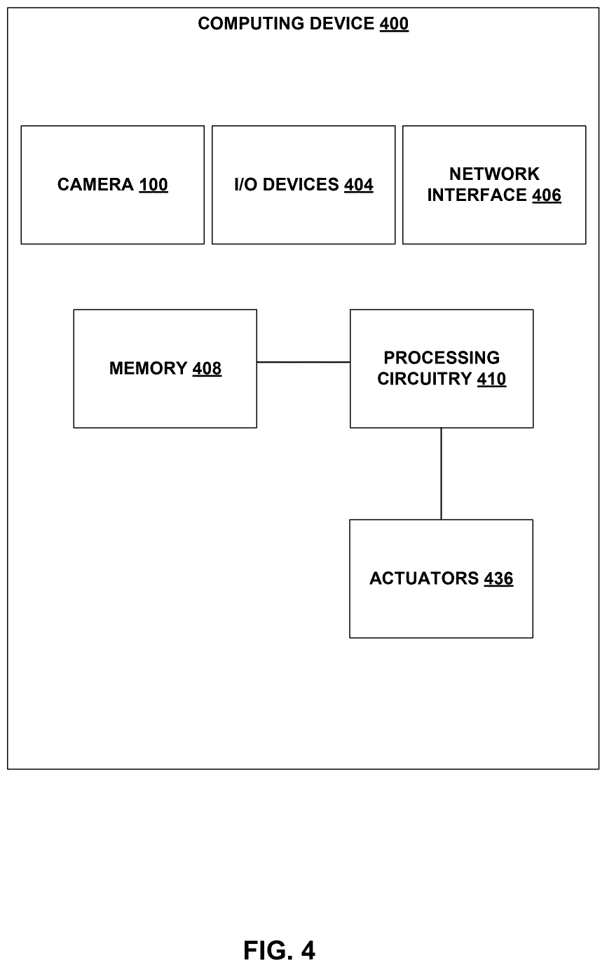

Flex circuit 216 may be positioned on or within base 204 and may be configured to control actuators 236a-236d (collectively, “actuators 236”). In the example shown, actuator 236a comprises magnets 232a and coil 234a, actuator 236b comprises magnets 232b and coil 234b, actuator 236c comprises magnets 232c and coil 234c, and actuator 236d comprises magnets 232d and coil 234d. For example, actuators 236 may comprise voice coil motors in which the coils are electrically connected to flex circuit 216 and magnets 232a-232d (collectively, “magnets 232) are attached to rotator 206. Flex circuit 216 may be attached to base 204, and may include an interconnect (not shown) configured to electrically and/or communicatively connect to I/O devices 404 (FIG. 4), such that processing circuitry 410 of computing device 400 (FIG. 4) may control actuators 236 to control variable aperture 202 and the amount of light allowed through variable aperture 202 to be received by sensor 114.

In the examples shown, base 204 defines recesses 210a-210d that are circumferentially distributed around base 204, and rotator 206 comprises projections 208a-208b configured to move within recesses 210a-210d. Projections 208a-208d and recesses 210a-210d may be substantially the same as projections 108a, 108b and recesses 110a, 110b of FIG. 1. In some examples, projections 208a-208d may be formed via molding process, and may be molded around a strengthening component. For example, projections 208a-208d may be a plastic and/or PTFE molded around a metal material, such as steel.

Base 204 may include one or more yokes (not shown), which may be magnetic yokes configured to fix a nominal T0 rotational position of rotator 206 along a rotational arc. For example, the nominal T0 rotational position of rotator 206 may be a center of the circumferential length of recesses 210a-210d defined by base 204, e.g., the center of the rotational range of rotator 206. In other examples, the nominal T0 rotational position of rotator 206 may be a position corresponding to a clear aperture 122 area that variable aperture 202 is expected to be at to most, e.g., such that rotator 206 and aperture blades 212 may be held at that default position by the yokes with actuators 236 drawing minimal or no power. For example, which coils 234a-208d are turned off, the yokes may interact with magnets 232 to cause rotator 206 to rotate to the nominal T0 position. In some examples, the yokes may be insert molded to base 204, e.g., underneath coils 234a-234d.

In some examples, base 204 defines a plurality of slots 240a-240d. Each slot 240a-240d may be configured to enable insertion of a respective projection 208a-208d into a corresponding recess 210a-210d defined by base 204. In the exploded view of the example shown in FIG. 2, rotator 206 is not yet inserted into base 204. During assembly of variable aperture 202, the projections 208a-208d of rotator 206 may be aligned with slots 240a-240d and inserted into recesses 210a-210d through slots 240a-240d. A plurality of plugs (not shown) may be configured to be inserted into the plurality of slots 240a-240d, e.g., after assembly of rotator 206 within base 204. The plurality of plugs may be configured to retain projections 208a-208d within respective recesses 210a-210d.

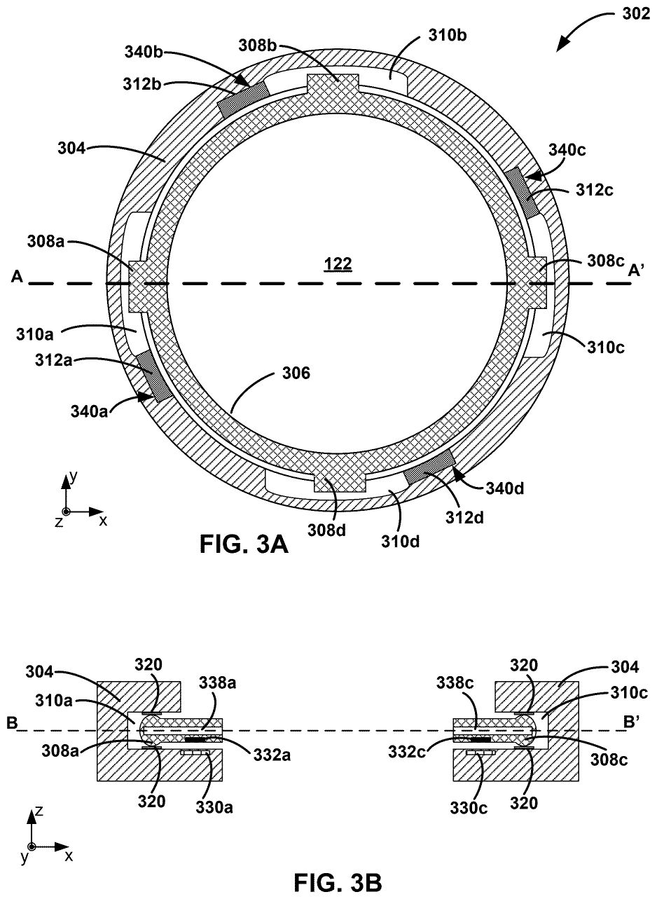

FIG. 3A is a cross-sectional top view of a rotator within a base of an example variable aperture 302 along the line B-B′ shown in FIG. 3B, in accordance with one or more aspects of the present disclosure. FIG. 3B is a cross-sectional side view of the example variable aperture 302 along the line A-A′ shown in FIG. 3A, in accordance with one or more aspects of the present disclosure. FIGS. 3A and 3B are described together below. Variable aperture 302 may be substantially similar to variable apertures 102 and 202 described above except for the differences described herein.

In the example shown, variable aperture 302 includes base 304 defining a plurality of circumferentially distributed recesses 310a-310d and rotator 306 comprising a plurality of projections 308a-308d. In the example shown, variable aperture 302 as shown is assembled, e.g., projections 308a-308d are inserted through slots 340a-340d, respectively, and are positioned within respective circumferentially distributed recesses 310a-310d. Variable aperture 302 includes plugs 312a-312d inserted into slots 340a-340d. Plugs 312a-312d may be configured to retain projections 308a-308d within respective recesses 310a-310d.

Referring to FIG. 3B, variable aperture 302 may include a friction reducing material, e.g., grease 320, disposed within the plurality of recesses 310a-310d. Grease 320 may be configured to reduce friction between projections 308a-308d and the inner surfaces of the material of base 304 defining the plurality of recesses 310a-310d surrounding projections 308a-308d. Base 304 may also include a plurality of yokes 330a-330d, which may each be substantially similar to yokes of variable aperture 202 described above. Rotator 306 may include a plurality of magnets 332a-332d, shown in FIG. 3B as positioned along projections 308a-308d and which may be substantially similar to magnets 232a, 232b and may be a part of actuators of variable aperture 302.

In the example shown, base 304 defines recesses 310a-310d configured to surround, or enclose, projections 308a-308d on three sides or from three directions, e.g., the top and bottom in the positive and negative z-directions, and the radially outwards side, to contain and/or protect rotator 306 from a force or from contacting a cover of a camera including variable aperture 302 such as may occur from dropping a device including the camera. In some examples, projections 308a-308d may be formed by a molding process in which the projections 308a-308d are molded around strengthening components 338a-338d. For example, projections 308a-308d may be a plastic, a polymer, PTFE, or the like, molded around a metal material, such as steel. In some examples, one or both of the material of base 304 defining recesses 310a-310d and the strengthening components 338a-338d of projections 308a-308d may reduce a deformation of rotator 306, e.g., from a force, such as a vertical force in the negative z-direction as shown such as from an impact after dropping a device including variable aperture 302. The reduction of vertical deformation of rotator 306 may enable a camera, such as camera 100, to reduce a z-height relief and thereby reduce a bump height of the camera.

FIG. 4 is an example computing system 400 that may be used with a camera 100 and any of variable apertures 102, 202, and 302, in accordance with one or more aspects of the present disclosure. Computing system 400 may implement methods for controlling operations of camera 100, controlling variable aperture 102, 202, and/or 302, and/or image processing of images captured with the camera 100. In some examples, computing system 400 may be any of various types of devices, including, but not limited to, a personal computer system, desktop computer, laptop, notebook, tablet or pad device, slate, or netbook computer, mainframe computer system, handheld computer, workstation, network computer, a camera, a set top box, a mobile device, a wireless phone, a smartphone, a consumer device, video game console, handheld video game device, application server, storage device, a television, a video recording device, a peripheral device such as a switch, modem, router, or in general any type of computing or electronic device.

In the example shown, computing system 400 may include processing circuitry 410 (e.g., one or more processors) coupled to a memory 408. In some examples, processing circuitry 410 may be configured to control actuators 436 to rotate rotator 106, 206, and/or 306. Actuators 436 may be substantially similar to actuators 236, and may be configured to rotate rotator 106, 206, and/or 306, e.g., along a rotational arc. Computing system 400 also may include a network interface 406, input/output devices 404, e.g., a cursor control device, mouse, touchpad, trackball, a keyboard, a display, or the like. Computing system 400 also may include one or more cameras 100 which may include a variable aperture 102, 202, and/or 302.

Memory 408 may be configured to store program instructions and/or data accessible by processing circuitry 410. Memory 408 may be implemented using any suitable memory technology, such as static random access memory (SRAM), synchronous dynamic RAM (SDRAM), nonvolatile/flash-type memory, or any other type of memory. Program instructions may be configured to implement various interfaces, methods and/or data for controlling operations of camera 100, controlling variable apertures 102, 202, and/or 302, or for capturing and processing images with camera 100 or other methods or data, for example interfaces and methods for capturing, displaying, processing, and storing images captured with camera 100. In some examples, program instructions and/or data may be received, sent or stored upon different types of computer-accessible media or on similar media separate from system memory 408 or computing system 400.

Network interface 406 may be configured to allow data to be exchanged between computing system 400 and other devices attached to a network (e.g., carrier or agent devices) or between nodes of computing system 400. Network interface 406 may include one or more networks including but not limited to Local Area Networks (LANs) (e.g., an Ethernet or corporate network), Wide Area Networks (WANs) (e.g., the Internet), wireless data networks, some other electronic data network, or some combination thereof. Network interface 406 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 404 may include one or more display terminals, keyboards, keypads, touchpads, scanning devices, voice or optical recognition devices, or any other devices suitable for entering or accessing data by computing system 400. Multiple input/output devices 404 may be present in computing system 400 or may be distributed on various nodes of computing system 400. In some examples, similar input/output devices 404 may be separate from computing system 400 and may interact with one or more nodes of computing system 400 through a wired or wireless connection, such as over network interface 406.

In the example shown, memory 408 may include program instructions which may be processor-executable to implement any element or action to support camera 100, including but not limited to image processing software and interface software for controlling camera 100. In some examples, images captured by camera 100 may be stored to memory 408. In addition, metadata for images captured by camera 100 may be stored using memory 408.

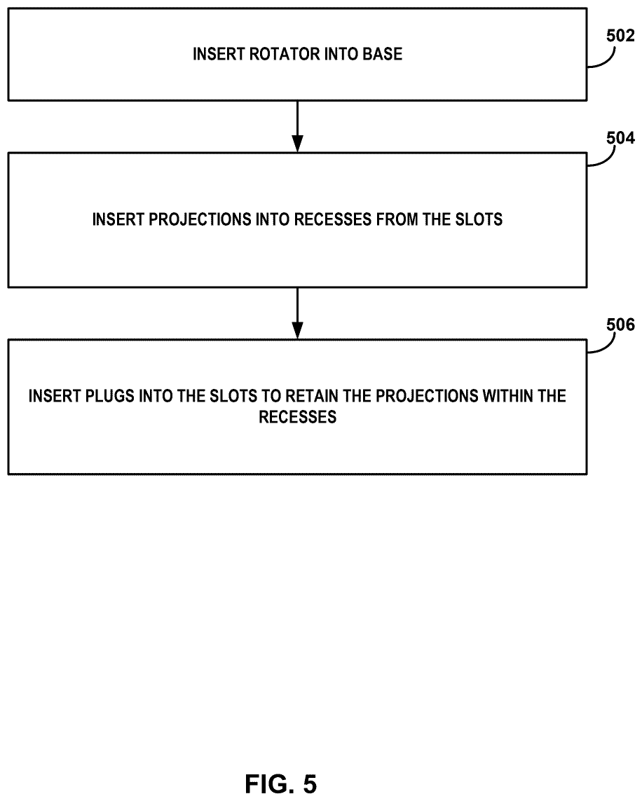

FIG. 5 is a flow chart of an example method of assembling a variable aperture of a camera of a mobile device, in accordance with one or more aspects of the present disclosure. Although the example method of FIG. 5 is described with respect to camera 100 of FIG. 1 and variable apertures 102, 202, and 302 of FIGS. 1-4, the example technique of FIG. 5 may be performed using any device including a variable aperture including a base defining recess and a rotator comprising projections. FIG. 5 is described with reference to FIGS. 3A and 3B.

An assembly may insert rotator 306 into base 340 (502). For example, the assembler may insert projections 308a-308d into respective slots 340a-340d of base 304. The assembly may insert the plurality of projections 308a-308d from the plurality of slots 340a-340d and into the plurality of corresponding recesses 310a-310d of base 304 (504). For example, the assembler may rotate rotator 306 such that projections 308a-308d move from slots 340a-340d into recesses 310a-310b. The assembler may then insert a plurality of plugs 312a-312d into the plurality of slots 340a-340d, e.g., to retain projections 308a-308d within recesses 310a-310d.

Computing system 400 and devices described herein may include any combination of hardware or software that can perform the indicated functions, including computers, network devices, Internet appliances, PDAs, wireless phones, pagers, video or still cameras, and the like. Computing system 400 may also be connected to other devices that are not illustrated, or instead may operate as a stand-alone system. In addition, the functionality provided by the illustrated components may, in some examples, be combined in fewer components or distributed in additional components. Similarly, in some examples, the functionality of some of the illustrated components may not be provided and/or other additional functionality may be available.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, may include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

This disclosure includes the following examples:

Example 1: A variable aperture for a camera of a mobile computing device, the variable aperture including: a plurality of aperture blades, a position of the plurality of aperture blades controlling an amount of light that reaches a sensor of the camera; a rotator configured to rotate the plurality of aperture blades along a rotational arc, wherein rotation of the plurality of aperture blades along the rotational arc adjusts the position of the plurality of aperture blades; and a base configured to house the rotator, the base defining a plurality of circumferentially distributed recesses, wherein the rotator comprises a plurality of projections configured to move within the plurality of recesses.

Example 2: The variable aperture of example 1, wherein the base defines a plurality of slots, each slot of the plurality of slots configured to enable insertion of a projection of the plurality of projections into a corresponding recess of the plurality of recesses.

Example 3: The variable aperture of example 2, wherein the plurality of recesses include material configured to surround the projections for at least a portion of the rotational arc.

Example 4: The variable aperture of example 3, further comprising a plurality of plugs configured to be inserted into the plurality of slots after assembly of the rotator within the base, wherein the plurality of plugs are configured to retain the projections within the recesses.

Example 5: The variable aperture of example 3 or example 4, further comprising grease disposed within the plurality of recesses.

Example 6: The variable aperture of any one of examples 1 through 5, wherein the plurality of projections are formed via a molding process, and wherein the plurality of projections are molded around a strengthening component.

Example 7: The variable aperture of any one of examples 1 through 6, further comprising an actuator configured to rotate the rotator along the rotational arc.

Example 8: The variable aperture of any one of examples 1 through 7, further comprising a magnetic yoke configured to fix a nominal T0 rotational position of the rotator along the rotational arc.

Example 9: A camera of a mobile computing device, the camera including: a lens configured to image light to a sensor; a variable aperture includes a plurality of aperture blades, a position of the plurality of aperture blades controlling an amount of light that reaches the sensor; a rotator configured to rotate the plurality of aperture blades along a rotational arc, wherein rotation of the plurality of aperture blades along the rotational arc adjusts the position of the plurality of aperture blades; a base configured to house the rotator, the base defining a plurality of circumferentially distributed recesses, wherein the rotator comprises a plurality of projections configured to move within the plurality of recesses; and the sensor.

Example 10: The camera of example 9, wherein the base defines a plurality of slots, each slot of the plurality of slots configured to enable insertion of a projection of the plurality of projections into a corresponding recess of the plurality of recesses.

Example 11: The camera of example 10, wherein the plurality of recesses include material configured to surround the projections for at least a portion of the rotational arc.

Example 12: The camera of example 11, further comprising a plurality of plugs configured to be inserted into the plurality of slots after assembly of the rotator within the base, wherein the plurality of plugs are configured to retain the projections within the recesses.

Example 13: The camera of example 11 or example 12, further comprising grease disposed within the plurality of recesses.

Example 14: The camera of any one of examples 9 through 13, wherein the plurality of projections are formed via a molding process, and wherein the plurality of projections are molded around a strengthening component.

Example 15: The camera of any one of examples 9 through 14, further comprising an actuator configured to rotate the rotator along the rotational arc.

Example 16: The camera of any one of examples 9 through 15, further comprising a magnetic yoke configured to fix a nominal T0 rotational position of the rotator along the rotational arc.

Example 17: A method of assembling a variable aperture of a camera of a mobile device, the method including: inserting a rotator into a base, wherein the rotator comprises a plurality of projections and is configured to rotate a plurality of aperture blades along a rotational arc, wherein the base is configured to house the rotator and defines a plurality of circumferentially distributed recesses, wherein the base comprises the plurality of slots configured to enable insertion of a projection of the plurality of projections into a corresponding recess of the plurality of recesses, wherein inserting the rotator into the base comprises inserting the plurality of projections into corresponding slots of the plurality of slots; and inserting the plurality of projections, from the plurality of slots, into the plurality of corresponding recesses of the base.

Example 18: The method of example 17, further includes inserting a plurality of plugs into the plurality of slots, wherein the plurality of plugs are configured to retain the projections within the recesses.

Various examples of the disclosure have been described. Any combination of the described systems, operations, or functions is contemplated. These and other examples are within the scope of the following claims.

1. A variable aperture for a camera of a mobile computing device, the variable aperture comprising:
a plurality of aperture blades, a position of the plurality of aperture blades controlling an amount of light that reaches a sensor of the camera;
a rotator configured to rotate the plurality of aperture blades along a rotational arc, wherein rotation of the plurality of aperture blades along the rotational arc adjusts the position of the plurality of aperture blades; and
a base configured to house the rotator, the base defining a plurality of circumferentially distributed recesses,
wherein the rotator comprises a plurality of projections configured to move within the plurality of recesses.

2. The variable aperture of claim 1, wherein the base defines a plurality of slots, each slot of the plurality of slots configured to enable insertion of a projection of the plurality of projections into a corresponding recess of the plurality of recesses.

3. The variable aperture of claim 2, wherein the plurality of recesses include material configured to surround the projections for at least a portion of the rotational arc.

4. The variable aperture of claim 3, further comprising a plurality of plugs configured to be inserted into the plurality of slots after assembly of the rotator within the base, wherein the plurality of plugs are configured to retain the projections within the recesses.

5. The variable aperture of claim 3, further comprising grease disposed within the plurality of recesses.

6. The variable aperture of claim 1, wherein the plurality of projections are formed via a molding process, and wherein the plurality of projections are molded around a strengthening component.

7. The variable aperture of claim 1, further comprising an actuator configured to rotate the rotator along the rotational arc.

8. The variable aperture of claim 1, further comprising a magnetic yoke configured to fix a nominal T0 rotational position of the rotator along the rotational arc.

9. A camera of a mobile computing device, the camera comprising:
a lens configured to image light to a sensor;
a variable aperture comprising:
a plurality of aperture blades, a position of the plurality of aperture blades controlling an amount of light that reaches the sensor;
a rotator configured to rotate the plurality of aperture blades along a rotational arc, wherein rotation of the plurality of aperture blades along the rotational arc adjusts the position of the plurality of aperture blades;
a base configured to house the rotator, the base defining a plurality of circumferentially distributed recesses,
wherein the rotator comprises a plurality of projections configured to move within the plurality of recesses; and
the sensor.

10. The camera of claim 9, wherein the base defines a plurality of slots, each slot of the plurality of slots configured to enable insertion of a projection of the plurality of projections into a corresponding recess of the plurality of recesses.

11. The camera of claim 10, wherein the plurality of recesses include material configured to surround the projections for at least a portion of the rotational arc.

12. The camera of claim 11, further comprising a plurality of plugs configured to be inserted into the plurality of slots after assembly of the rotator within the base, wherein the plurality of plugs are configured to retain the projections within the recesses.

13. The camera of claim 11, further comprising grease disposed within the plurality of recesses.

14. The camera of claim 9, wherein the plurality of projections are formed via a molding process, and wherein the plurality of projections are molded around a strengthening component.

15. The camera of claim 9, further comprising an actuator configured to rotate the rotator along the rotational arc.

16. The camera of claim 9, further comprising a magnetic yoke configured to fix a nominal T0 rotational position of the rotator along the rotational arc.

17. A method of assembling a variable aperture of a camera of a mobile device, the method comprising:
inserting a rotator into a base, wherein the rotator comprises a plurality of projections and is configured to rotate a plurality of aperture blades along a rotational arc, wherein the base is configured to house the rotator and defines a plurality of circumferentially distributed recesses, wherein the base comprises a plurality of slots configured to enable insertion of a projection of the plurality of projections into a corresponding recess of the plurality of recesses,
wherein inserting the rotator into the base comprises inserting the plurality of projections into corresponding slots of the plurality of slots; and
inserting the plurality of projections, from the plurality of slots, into the plurality of corresponding recesses of the base.

18. The method of claim 17, further comprising:
inserting a plurality of plugs into the plurality of slots, wherein the plurality of plugs are configured to retain the projections within the recesses.
